(19) United States
(12) Patent Application Publication
(10) Pub. No.: US 2004/0136282 A1
(43) Pub. Date: Jul. 15, 2004

(54) Method for calibrating center error offset in an optical drive and control system capable of calibrating center error offset

(76) Inventor: Chih-Yuan Chen, Chang Hua County (TW)

Correspondence Address: BIRCH STEWART KOLASCH & BIRCH, PO BOX 747, FALLS CHURCH, VA, 22040-0747, US

(21) Appl. No.: 10/743,147

(22) Filed: Dec. 23, 2003

(30) Foreign Application Priority Data
Jan. 8, 2003 (TW) 092100459

(51) Int. Cl. G11B 7/095

(52) U.S. Cl. 369/44.35; 369/53.28

(57) ABSTRACT

A method for calibrating a center error offset in an optical drive and a control system capable of calibrating the center error offset. The method includes the steps of: controlling a focusing coil to focus on a rotating disk; controlling a tracking coil with different tracking coil control values; measuring and storing the amplitude of a tracking error TE signal and a center level of the center error CE signal responding to each control value; and selecting a largest amplitude of the tracking error TE signal and setting the responding center level of the center error CE signal as an optimal center error offset. Because the calibrating method determines the optimal center error offset by outputting different tracking coil control signals, it considers not only the unbalance of the gains of photo detectors and the optical deviation due to the assembly misalignment, but also the offset in a power drive.

### BACKGROUND OF THE INVENTION

1. Field of the Invention

The invention relates to a method for calibrating a center error signal offset, and more particularly to a calibrating method for determining an optimal center error signal offset according to different tracking coil control signals, and an optical drive control system capable of calibrating the center error signal offset.

2. Description of the Related Art

In an optical write/reproduction system, a tracking error TE signal is typically obtained by means of differential push-pull signal, so that the offset of the push-pull signal caused by the radial shift of the objective lens may be eliminated, and the laser beams may be illuminated to the track center of a disk. However, the radial shift of the objective lens may deteriorate the required optical property. For instance, the effective laser power emitting to the disk and the light beams received by the photo detectors are reduced. Because the offset of the push-pull signal represents the radial offset of the objective lens (referred to as a center error (CE) herein below), the center error CE signal may serve as an error signal for controlling a sled to keep the center error CE signal or the radial offset of the objective lens in an acceptable range and to prevent the optical property from being deteriorated. An United States patent application publication No. 20030206505 titled “Optical disk drive with a servo control system” discloses a method for generating the center error CE signal and the tracking error TE signal, and discloses a method for controlling the sled according to the center error CE signal.

FIG. 1 shows a block diagram of a conventional tracking servo control system. Referring to FIG. 1, the control system includes a sled motor and pickup assembly 11, a lens unit 12, a spindle motor 13, a pre-amplifier 14, adders 15 and 16, a sled motor servo control unit 17, a long/short tracking calculation unit 18, a tracking coil servo control unit 19, and a power drive 20. The pre-amplifier 14 receives signals from the sled motor and pickup assembly 11 and then generates a tracking error signal TE′ and a center error signal CE′.

FIG. 2 shows a typical circuit of generating the center error CE signal and the tracking error TE signal. Generally, the main photo detector 21 generates four signals, including A, B, C and D and the auxiliary photo detector 23 generates four signals, including E, F, G and H. The center error CE signal is generated by the OP amplifier 22. That is:

CE=(A+D)−(B+C).

The tracking error TE signal is generated by the OP amplifier 24, 25 and 26 according to the signals E, F, G and H and the center error CE signal. That is:

TE=[(A+D)−(B+C)]+K[(E+G)−(F+H)]

Referring to FIG. 1 again, the adders 15 and 16 add a center error offset CE_offset and a tracking error offset TE_offset to the center error signal CE′ and the tracking error signal TE′, respectively, to produce a desired center error CE signal and a desired tracking error TE. The sled motor servo control unit 17 utilizes the center error CE signal to generate a sled control signal FMO during the data reproduction. The long/short tracking calculation unit 18 and the tracking coil servo control unit 19 utilize the center error CE signal and the tracking error TE signal to generate a tracking coil control signal TRO to control the tracking coil (not shown) during the seeking action. As mentioned above, the object of using the center error CE signal to control the sled is to control the radial offset of the objective lens within an acceptable range. Under an ideal state, when the center error CE signal is equal to the center error offset CE_offset, the objective lens is radially controlled at an optimal optical position. FIG. 3 shows a schematic illustration of the shift of the objective lens 12′ caused by the offset of the power drive 20. As shown in FIG. 3, the power drive 20 outputs control signals T+ and T− to control the shift of the objective lens 12′ and the offset of the power drive 20 itself may cause the shift of the objective lens 12′.

Typically, there are two methods to obtain the center error offset CE_offset. The first method is to turn on the laser light source and drive the objective lens to move downward, and then measure the level of the center error CE signal as the center error offset CE_offset. This method can only obtain the circuit offsets of the pickup assembly and the pre-amplifier and tends to neglect the optical deviations caused by the unbalance of the gains of the photo detectors and the assembly misalignment. The second method is to make the objective lens move freely after a focus-on process, and measure the level of the center error CE signal as the center error offset CE_offset. When the system has the offset of the power drive as shown in FIG. 3, however, the second method cannot obtain the optimal center error offset CE_offset because the objective lens is moved and the center of the optical path is shifted.

### SUMMARY OF THE INVENTION

In view of the above-mentioned problems, it is therefore an object of the invention to provide a method for calibrating a center error offset. The method determines an optimal center error offset by outputting different tracking coil control signals. The method may simultaneously consider the unbalance of the gains among the photo detectors, the optical deviation caused by the assembly misalignment, and the offset of the power drive.

To achieve the above-mentioned object, the invention provides a method for calibrating a center error offset. The method includes the steps of: switching to a calibrating mode; controlling a tracking coil with different tracking coil control values; measuring and storing the amplitude of a tracking error TE signal and the center level of the center error CE signal responding to each control value; and setting the center level of the center error CE signal responding to the largest amplitude of the tracking error TE signal as an optimal center error offset.

Because the calibrating method determines the optimal center error offset by outputting different tracking coil control signals, it considers not only the unbalance of the gains among the photo detectors and the optical deviation due to the assembly misalignment, but also the offset in a power drive.

### BRIEF DESCRIPTION OF THE DRAWINGS

FIG. 1 shows a block diagram of a tracking servo control system.

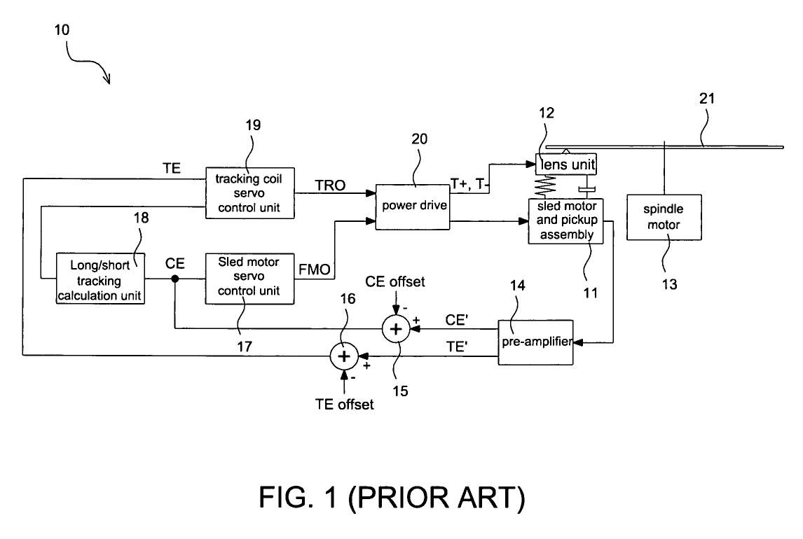

FIG. 2 shows a typical circuit of generating the center error CE signal and the tracking error TE signal.

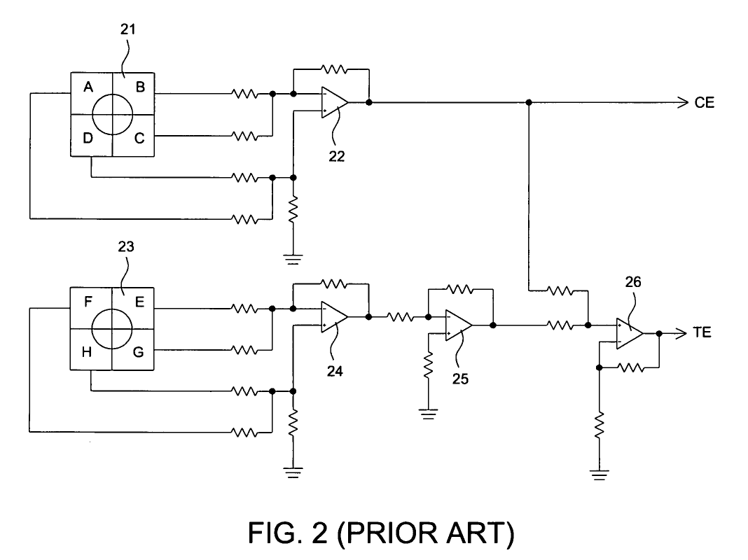

FIG. 3 shows a schematic illustration of the shift of the objective lens caused by the offset of the power drive.

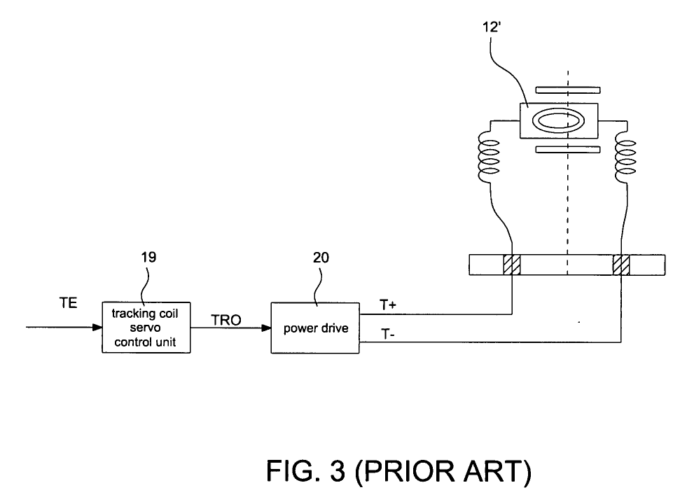

FIG. 4 shows the optical drive control system of the invention capable of calibrating the center error offset.

FIG. 5 shows a waveform of a tracking error TE signal responding to a certain tracking coil control signal TRO.

FIG. 6 shows a waveform of a center error CE signal responding to a certain tracking coil control signal TRO.

FIG. 7 shows the relationship between the amplitude of the tracking error TE signal and the center level of the center error CE signal responding to different tracking coil control signals TRO.

FIG. 8 shows a flow chart of the method of the invention for calibrating the center error offset.

### DETAILED DESCRIPTION OF THE INVENTION

The method for calibrating a center error offset and the optical drive control system capable of calibrating the center error offset of the invention will be described with reference to the accompanying drawings.

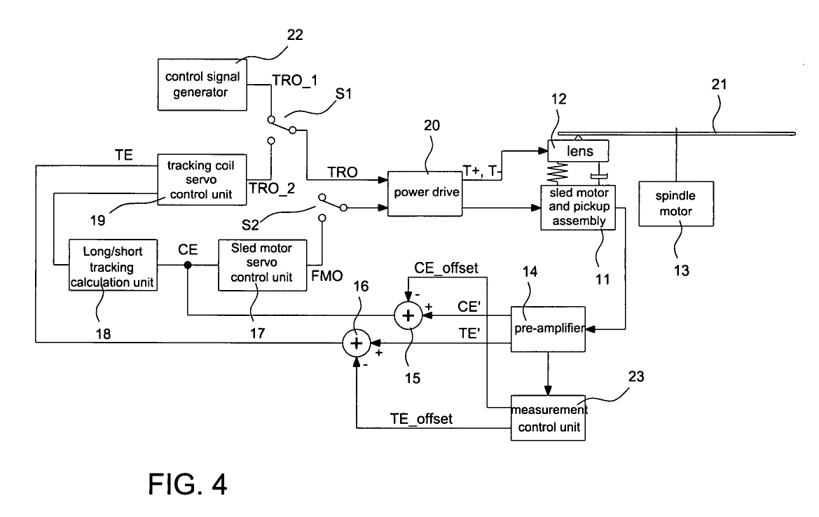

FIG. 4 shows the optical drive control system of the invention capable of calibrating the center error offset. The method of calibrating the center error offset is to determine the optimal center error offset by outputting different tracking coil control signals. Referring to FIG. 4, in addition to a sled motor and pickup assembly 11, a lens set 12, a spindle motor 13, a pre-amplifier 14, adders 15 and 16, a sled motor servo control unit 17, a long/short tracking calculation unit 18, a tracking coil servo control unit 19, and a power drive 20, the control system further includes a control signal generator 22 and a measurement control unit 23. The control signal generator 22 generates plural sets of different tracking coil control signals so as to control the tracking coil to drive the lens set 12 to different positions. The measurement control unit 23 receives a signal from the pre-amplifier 14, generates and stores data of associated signals responding to different tracking coil control signals. For example, the data may be the amplitude of the tracking error TE, the center level of the center error CE, the amplitude of the wobble signal, the amplitude of the radio frequency (RF) signal, and the like. As shown in FIG. 4, when the system calibrates the center error offset, the switch S1 connects the tracking coil control signal TRO_1 output from the control signal generator 22 to the power drive 20, and the switch S2 is off to prevent the output of the sled motor servo control unit 17 from being outputted to the power drive 20. Consequently, when the system calibrates the center error offset, the sled is not controlled by the sled motor servo control unit 17 and is held at a fixed position.

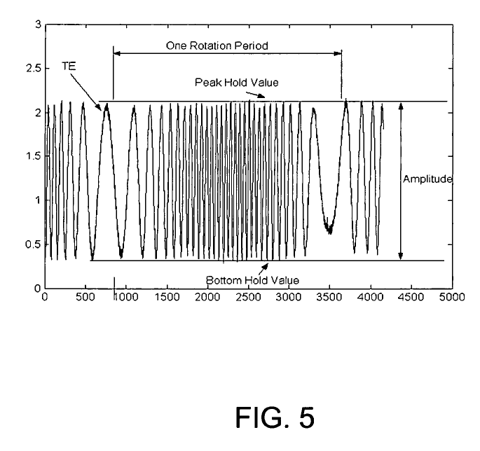

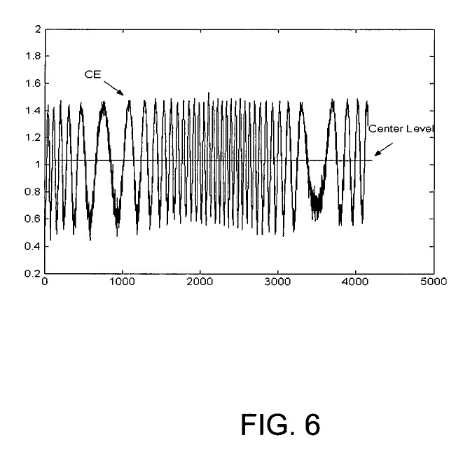

FIG. 5 shows a waveform of a tracking error TE signal responding to a certain tracking coil control signal TRO. FIG. 6 shows a waveform of a center error CE signal responding to a certain tracking coil control signal TRO. As shown in FIGS. 4 and 5, because the pickup, sled and lens set are static responding to the same tracking coil control signal TRO when the calibrating action is performed, the waveforms of the tracking error TE signal and the center error CE signal change periodically owing to the track-crossing operations of the pickup. The measurement control unit 23 measures and stores the amplitude of the tracking error TE signal and the center level of the center error CE signal responding to the tracking coil control signal TRO. The amplitude of the tracking error TE signal and the center level of the center error CE signal are the parameters to be measured in this embodiment. Therefore, the system generates a set of amplitude of the tracking error TE signal and the center level of the center error CE signal for each tracking coil control signal TRO. When the range of the tracking coil control signal TRO is all output, the measurement control unit 23 finds out the largest amplitude of the tracking error TE, and the center level of the center error CE signal responding to the largest amplitude is regarded as the optimal center error offset CE_offset.

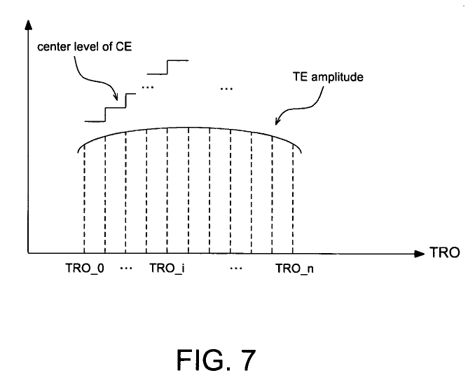

FIG. 7 shows the relationship between the amplitude of the tracking error TE signal and the center level of the center error CE signal responding to different tracking coil control signals TRO. As shown in FIG. 7, when the tracking coil control signal varies from TRO_0 to TRO_n, the amplitude of the tracking error TE signal changes from a small value to a large value and then from a large value to a small value. The so-called optimal optical path is defined as the path with the optimal optical efficiency, which also means that the track-crossing signal generated under the free run has the largest amplitude. Hence, as long as the center level of the center error CE signal responding to the largest TE signal amplitude is selected, the responding center level of the center error CE signal may serve as the optimal center error offset CE_offset because the optimal optical path is obtained in the state. Although the embodiment selects the optimal center error offset CE_offset according to the amplitude of the tracking error TE signal, data of other associated signals may be utilized to find the optimal center error offset CE₁₃ offset. The data of associated signals may be, for example, the amplitude of a radio frequency (RF) signal (suitable for the disk on which data is recorded), the amplitude of the center error CE signal itself, and the amplitude of the wobble signal on the disk.

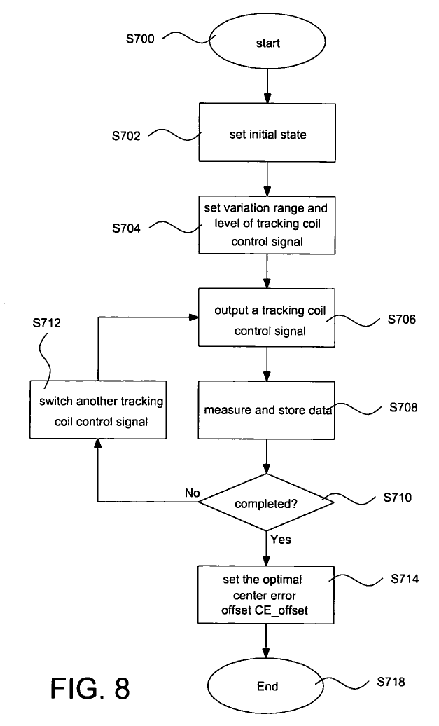

FIG. 8 shows a flow chart of the method of the invention for calibrating the center error offset. Please refer to FIG. 8 as well as the architecture of FIG. 4, the method of the invention for calibrating the center error offset determines the optimal center error offset CE_offset by outputting a range of different tracking coil control signals and storing data of associated optical signals responding to different tracking coil control signals. The method of the invention for calibrating the center error offset includes the following steps.

Step S700: start.

Step S702: set initial state. Control a focusing coil to focus on a rotating disk and control a sled motor to keep a sled static.

Step S704: set the variation range and variation level of the tracking coil control signal. That is, the method sets the data range and variation level output from the control signal generator 22.

Step S706: output a tracking coil control signal to the power control unit 20 to actuate the tracking coil to control the movement of the lens set.

Step S708: measure and store the related data. That is, the related data of the associated optical signals, such as the amplitude of the tracking error TE signal and the center level of the center error CE signal, are measured and stored.

Step S710: detect whether or not the range of different tracking coil control signal has been all output. If they are all outputted, the process jumps to step S714; or otherwise the process jumps to step S712.

Step S712: switch to a next tracking coil control signal and the process jumps back to step S706.

Step S714: set the optimal center error offset CE_offset. That is, the largest amplitude of the tracking error TE signal is sought, and the center level of the center error CE signal responding to the tracking error TE signal of the largest amplitude serves as the optimal center error offset CE_offset.

Step S718: End.

In the above-mentioned steps, the largest amplitude of the tracking error TE signal is sought and set according to the largest amplitude of the tracking error TE signal. Of course, it is also possible to use data of other signals such as the wobble signal and the RF signal to seek the optimal center error offset CE_offset.

While certain exemplary embodiments have been described and shown in the accompanying drawings, it is to be understood that such embodiments are merely illustrative of and not restrictive on the broad invention, and that this invention not be limited to the specific construction and arrangement shown and described, since various other modifications may occur to those ordinarily skilled in the art.

What is claimed is:

1. A method for calibrating a center error offset in a control system of an optical drive, the optical drive having photo detectors for generating an optical signal, a focusing coil for controlling a focus state, a sled for setting the photo detectors and the focusing coil and a sled motor for controlling the movement of the sled, the method comprising the steps of:
controlling the focusing coil to focus on a rotating disk;
controlling the sled motor to keep the sled static;
controlling a tracking coil with different tracking coil control values;
measuring and storing data of the optical signal and a center level of a center error CE responding to each of the tracking coil control values; and
selecting a largest value from the data of the optical signal and setting the center level of the center error CE responding to the largest optical signal as a center error offset.

2. The method according to claim 1, wherein the optical signal is a tracking error TE signal and the data of the optical signal is the amplitude of the tracking error TE.

3. The method according to claim 1, wherein the optical signal is a radio frequency signal and the data of the optical signal is the amplitude of the radio frequency signal.

4. The method according to claim 1, wherein the optical signal is a wobble signal and the data of the optical signal is the amplitude of the wobble signal.

5. The method according to claim 1, wherein the optical signal is a center error CE signal and the data of the optical signal is the amplitude of the center error CE signal.

6. A control system of an optical drive capable of calibrating a center error offset, the control system having a sled motor and pickup assembly, a lens set, a pre-amplifier, a sled motor servo control unit, a long/short tracking calculation unit, a tracking coil servo control unit, and a power drive, characterized in that the control system further comprises:
a control signal generator for outputting different tracking coil control signals to the power drive in a calibrating mode; and
a measurement control unit for measuring and storing data of an optical signal and a center level of a center error CE signal responding to each of the tracking coil control signals in a calibrating process;
wherein the measurement control unit selecting a largest value of the optical signal and setting the center level of the center error CE signal responding to the largest value of the optical signal as a center error offset.

7. The control system according to claim 6, wherein the optical signal is a tracking error TE signal and the data of the optical signal is the amplitude of the tracking error TE.

8. The control system according to claim 6, wherein the optical signal is a radio frequency signal and the data of the optical signal is the amplitude of the radio frequency signal.

9. The control system according to claim 6, wherein the optical signal is a wobble signal and the data of the optical signal is the amplitude of the wobble signal.

10. The control system according to claim 6, wherein the optical signal is a center error CE signal and the data of the optical signal is the amplitude of a center error CE signal.
